(19) United States
(12) Patent Application Publication
(10) Pub. No.: US 2023/0278579 A1
(43) Pub. Date: Sep. 7, 2023

(54) METHOD AND APPARATUS FOR CUSTOMIZED AUTONOMOUS DRIVING

(71) Applicants: HYUNDAI MOTOR COMPANY, Seoul (KR); KIA CORPORATION, Seoul (KR)

(72) Inventors: Woo Hyun Kim, Suwon-si (KR); Ja Yoon Goo, Anyang-si (KR); Hong Gyu Lee, Goyang-si (KR)

(73) Assignees: HYUNDAI MOTOR COMPANY, Seoul (KR); KIA CORPORATION, Seoul (KR)

(21) Appl. No.: 17/986,635

(22) Filed: Nov. 14, 2022

(30) Foreign Application Priority Data
Mar. 3, 2022 (KR) 10-2022-0027723

(51) Int. Cl. B60W 60/00; B60W 40/09; B60K 35/00

(52) U.S. Cl. CPC B60W 60/001; B60W 40/09; B60K 35/00; B60K 2370/11; B60K 2370/148; B60W 2556/45; B60W 2556/10

(57) ABSTRACT

A method and apparatus for a customized autonomous driving apparatus, the apparatus including: an input-output unit configured to receive data input using one or more of a touch screen, a graphic user interface (GUI), speech recognition, and configured to visually and audibly output data received from another unit; a driving pattern learning unit configured to learn a driving pattern of a user with respect to one or more of information on acceleration, braking, steering, inter-vehicle distance, lane change, overtaking, and a response to road facilities, based on a process the user performs when driving; a driving pattern storage unit configured to store the driving pattern learned by the driving pattern learning unit; and an autonomous driving unit configured to perform autonomous driving based on one driving pattern input by the input-output unit.

### CROSS-REFERENCE TO RELATED APPLICATIONS

This application is based on and claims priority to Korean Patent Application Number 10-2022-0027723, filed Mar. 3, 2022, the disclosure of which is incorporated by reference herein in its entirety.

### TECHNICAL FIELD

The present disclosure relates to a customized autonomous driving apparatus and method.

### BACKGROUND

The content described in this section merely provides background information for the present disclosure and does not constitute the prior art.

As a portion of an advanced driver assistance system (ADAS) technology, there is an autonomous driving technology that a vehicle drives itself without the intervention of a driver. As a technology for performing autonomous driving, there are a predetermined number of levels, 0 to 5, that are based on an autonomous driving level. As the number of levels increases, functions performed by the vehicle itself without the intervention of the driver increase.

In autonomous driving level 0, the driver directly drives the vehicle. In autonomous driving level 3, the vehicle experiences autonomous driving in a certain section, and can respond to unexpected situations by monitoring the road environment, traffic conditions, and obstacle positions by itself. In autonomous driving level 5, in a state where the intervention of the driver is completely excluded, the vehicle drives itself to the destination, and all functions related to vehicle movement, such as parking, are fully automated.

Each user has a different driving pattern. For example, there are users who want to keep the inter-vehicle distance somewhat long for safety. At the same time, there are users who want to keep the inter-vehicle distance rather short due to the presence or absence of traffic lights and rapid movement.

The conventional autonomous driving technology has a problem of performing autonomous driving based only on the same driving method for all users.

In addition, there is a difference in the method of performing autonomous driving according to the type of autonomous driving vehicle. In this case, when the user drives a vehicle other than his/her own vehicle, there is a problem in that there is a difference in the autonomous driving method.

On the other hand, even in the case of exercise, there are health applications and social networking services (SNS) that can share an exercise method, an exercise process, and exercise content. However, there is a problem in that a database that can share driving patterns and driving history for vehicle driving does not exist.

### SUMMARY

According to one embodiment, the customized autonomous driving apparatus can receive and store driving patterns of other users from a cloud device, thus making it possible to perform autonomous driving based on various driving patterns.

According to one embodiment, when using the customized autonomous driving apparatus, even when driving other vehicles other than an own vehicle, the user can perform autonomous driving by applying the customized autonomous driving apparatus to the other vehicles based on the driving pattern used in the own vehicle.

According to one embodiment, the cloud device can receive driving patterns from the plurality of customized autonomous driving apparatuses and build a database. The cloud device can provide users with the number of downloads of driving patterns and in the order of their satisfaction. Therefore, a good driving pattern can be provided to the users.

### BRIEF DESCRIPTION OF THE DRAWINGS

FIG. 1 is a block diagram of a customized autonomous driving apparatus according to one embodiment of the present disclosure.

FIG. 2 is a flowchart of a customized autonomous driving method according to one embodiment of the present disclosure.

FIGS. 3A-3C are diagrams of a screen displayed on an input-output unit of the customized autonomous driving apparatus according to one embodiment of the present disclosure.

FIGS. 4A-4E are diagrams of a screen for the customized autonomous driving apparatus to edit a new driving pattern by combining a plurality of driving patterns according to one embodiment of the present disclosure.

FIG. 5 is a diagram of a method of exchanging data between a plurality of customized autonomous driving apparatus and one cloud device according to one embodiment of the present disclosure.

### DETAILED DESCRIPTION

The customized autonomous driving apparatus according to one embodiment may learn and store a driving pattern desired by a user and may receive and store a driving pattern of another user.

The customized autonomous driving apparatus according to one embodiment may receive and store a driving pattern desired by the user even when the user drives a vehicle other than his/her own vehicle.

The cloud device according to one embodiment may build a database by receiving driving patterns from all customized autonomous driving apparatuses. In addition, the cloud device can transmit a driving pattern to all customized autonomous driving apparatuses based on the established database.

The problems to be solved by the present disclosure are not limited to the problems mentioned above. Other problems not mentioned should be clearly understood by those having ordinary skill in the art from the following description.

Hereinafter, some embodiments of the present disclosure are described in detail with reference to the accompanying drawings. In the following description, like reference numerals preferably designate like elements, although the elements are shown in different drawings. Further, in the following description of some embodiments, a detailed description of related known components and functions, when considered to obscure the subject of the present disclosure, have been omitted for the purpose of clarity and brevity.

In describing the components of the embodiments, alphanumeric codes may be used such as first, second, i), ii), a), b), and the like, solely for the purpose of differentiating one component from others but not to imply or suggest the substance, the order, or the sequence of the components. Throughout this specification, when parts “include” or “comprise” a component, they are meant to further include other components, not to exclude components unless there is a particular description contrary thereto.

When a component, device, element, or the like of the present disclosure is described as having a purpose or performing an operation, function, or the like, the component, device, or element should be considered herein as being “configured to” meet that purpose or to perform that operation or function.

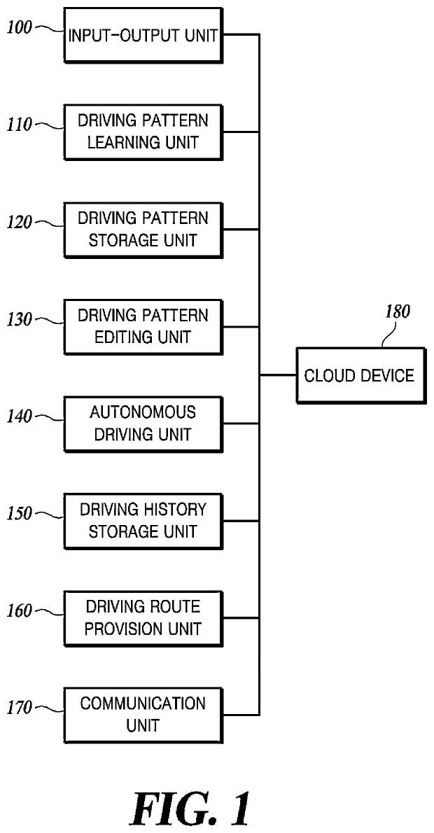

FIG. 1 is a block diagram of a customized autonomous driving apparatus according to one embodiment of the present disclosure.

Referring FIG. 1, the customized autonomous driving apparatus may include all or some of: an input-output unit 100; a driving pattern learning unit 110; a driving pattern storage unit 120; a driving pattern editing unit 130; an autonomous driving unit 140; a driving history storage unit 150; a driving route provision unit 160; and a communication unit 170.

The input-output unit 100 is an input/output device including a display. Methods of inputting data include a touch screen, a graphic user interface (GUI), and speech recognition. When the input method uses the touch screen, a user may input the driving pattern by touching an icon displayed on the touch screen. When the input method uses the GUI, the user may input a driving mode by clicking a displayed icon using a mouse cursor. When the input method uses the speech recognition, one driving mode may be input by recognizing the voice of the user.

The driving pattern learning unit 110 may include all or some of an acceleration pattern learning unit 112, a braking pattern learning unit 114, and a steering pattern learning unit 116. However, the acceleration pattern learning unit 112, the braking pattern learning unit 114, and the steering pattern learning unit 116 are only examples of configurations that the driving pattern learning unit 110 may include. The driving pattern learning unit 110 may further include an inter-vehicle distance learning unit (not illustrated), a lane change learning unit (not illustrated), and a road facilities correspondence learning unit (not illustrated).

In the method, the driving pattern learning unit 110 learns, a driving content of the user is classified into categories such as acceleration, braking, steering, inter-vehicle distance, lane change, overtaking, and a response of road facilities. Here, the road facilities refer to traffic lights, intersections, and speed bumps. In the response to road facilities, for example, when a yellow signal of a traffic light is turned on, user A accelerates and passes the corresponding intersection until the red light turns on, but user B may decelerate and stop in advance. As such, the response to road facilities is different for each user.

The driving pattern learning unit 110 may determine a pattern most frequently performed by the user for each category as a main pattern. The method for performing the above-described learning is one example of a method, and the method for performing the learning according to the present disclosure is not limited thereto.

The driving pattern storage unit 120 receives and stores the learned driving pattern from the driving pattern learning unit 110. When the driving pattern storage unit 120 stores the learned driving pattern, the name of the stored driving pattern may be stored together using the input-output unit 100. For example, when the user learns a driving pattern from a driving pattern learning unit, during a drive from Los Angeles to Las Vegas, the learned driving pattern may be stored as a name such as “James.” After the driving pattern storage unit 120 stores the driving pattern, the user may input a newly stored driving pattern using the input-output unit 100.

The driving pattern editing unit 130 classifies one or more criteria among a road type, a weather condition, and a traffic volume into a plurality of conditions. For example, in the case of the road type, it may be classified into conditions such as a highway, a city national road, and an out-of-town national road. Based on the classified conditions, the driving pattern editing unit 130 may combine and input a driving pattern suitable for each condition based on a previously stored driving pattern. Here, a process in which the driving pattern editing unit 130 creates a new driving pattern by combining the previously stored driving patterns may be defined as an editing process for the driving pattern.

The user can input the driving pattern to be applied to the classified condition. For example, assuming that there are a husband mode and a wife mode as previously stored driving patterns, the husband mode may be input on a highway, and the wife mode may be input on a city national road. In this case, the driving pattern editing unit 130 may generate a new driving pattern to perform autonomous driving based on the husband mode on a highway and autonomous driving based on the wife mode on a city national road.

The autonomous driving unit 140 performs autonomous driving based on one driving pattern input by the input-output unit 100.

When the vehicle arrives at the destination, the driving history storage unit 150 stores a driving history from a departure point to a destination. Here, the driving history refers to a driving route through which the vehicle is driven, a gradient of the driving route, a distance, a time, an average speed, a traffic congestion, and whether an accident has occurred. The driving history storage unit 150 stores one or more of a plurality of driving histories. The communication unit 170 may transmit the stored driving history to the cloud device 180 or receive the driving history stored in the cloud device 180. A detailed description of the communication unit 170 is described below.

The driving route provision unit 160 creates a route to the destination. Here, the route includes both the shortest route and the optimal route from a current location of the user to the destination. The optimal route means a route that allows smooth driving based on real-time traffic flow.

The driving route provision unit 160 may generate a driving route based on the stored driving history. For example, when a history of driving to the same destination by other users is stored in the cloud device 180, the communication unit 170 may receive the driving history from the cloud device 180, and the driving history storage unit 150 may receive the driving history from the communication unit 170 and store the driving history. The driving route provision unit 160 may generate the driving route based on the stored driving history.

The driving route provision unit 160 may provide the generated route to the driver using a visual and/or audio output device. The visual output devices include a center infotainment display (CID), a cluster, a rear seat entertainment (RSE), and a head up display (HUD). The CID communicates with navigation, mobile and audio systems to provide vehicle driving information and infotainment. The cluster provides information necessary for driving, such as a driving speed of a vehicle, a revolutions per minute (RPM) of an engine, a fuel amount of a vehicle, and a collision warning. The RSE is a display mainly used for entertainment activities for rear-seat occupants of a vehicle, but it also provides information on a driving status of the vehicle and navigation. The HUD projects the current speed of the vehicle, a fuel level, and navigation information as graphic images on a windshield of a driver. However, the display is not limited thereto, and may include any device capable of providing visual information to a driver or passengers. The auditory output device includes an audio and sound device of a vehicle.

The communication unit 170 may perform two-way communication with the cloud device 180. The communication unit 170 receives the driving pattern stored by the driving pattern storage unit 120 from the driving pattern storage unit 120 and receives the driving history stored by the driving history storage unit 150 from the driving history storage unit 150. The communication unit 170 may transmit the received driving pattern and/or driving history to the cloud device 180. The cloud device 180 may build a database based on the received driving pattern and/or driving history. The communication unit 170 may receive the driving pattern and driving history stored by the cloud device 180 from the cloud device 180 based on the built database. The communication unit 170 may receive the driving pattern and driving history stored by the cloud device 180.

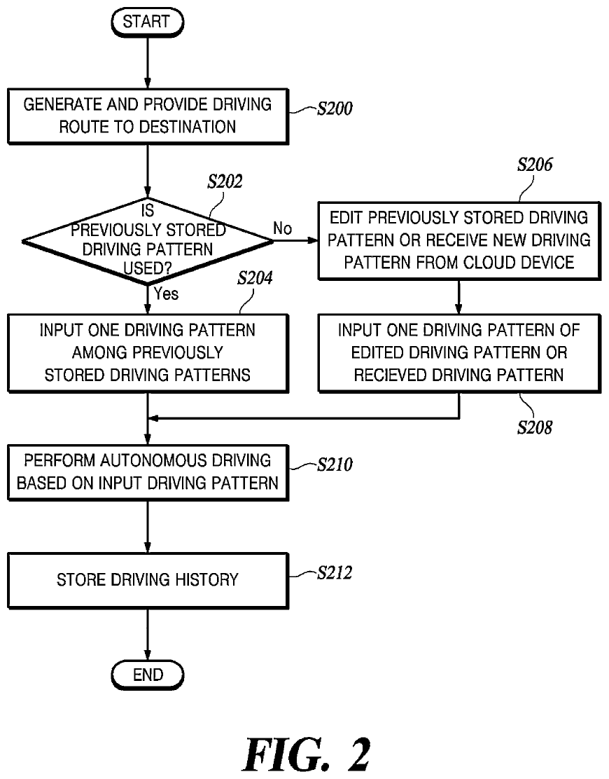

FIG. 2 is a flowchart of a customized autonomous driving method according to one embodiment of the present disclosure.

Referring to FIG. 2, the driving route provision unit 160 generates a route from the current location of the user to the destination and provides the generated route to the user using the input-output unit 100 (S200).

An input is received from the user as to whether to use a previously stored driving pattern (S202).

When the user inputs the previously stored driving pattern (S204), the autonomous driving is performed based on the input driving pattern (S210).

When the user touches and inputs a cloud access window instead of the previously stored driving pattern, the new driving pattern may be received and stored from the cloud device 180. Alternatively, the user may combine a plurality of driving patterns and store the combined driving pattern as a new driving pattern (S206).

One driving pattern among the driving pattern received from the cloud device 180 and/or the edited driving pattern, is input (S208). The autonomous driving is performed based on the input driving pattern (S210).

When the vehicle arrives at the destination, the autonomous driving is terminated, and the driving history from the departure point to the destination is stored (S212).

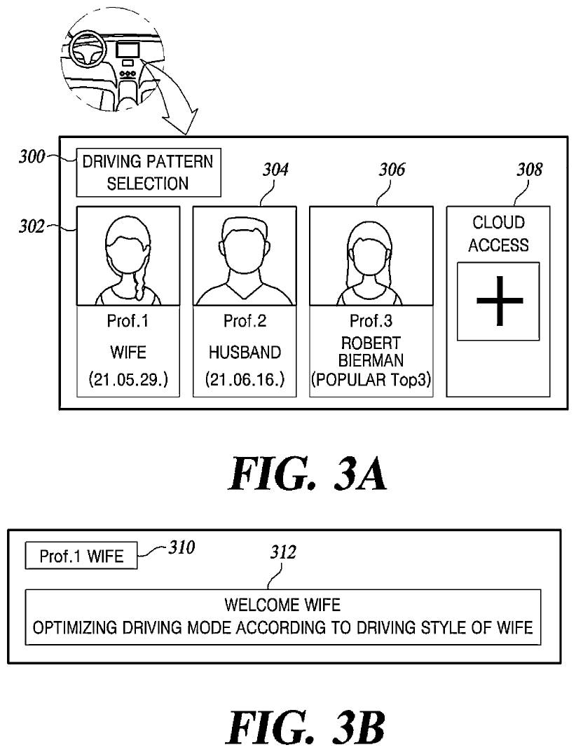

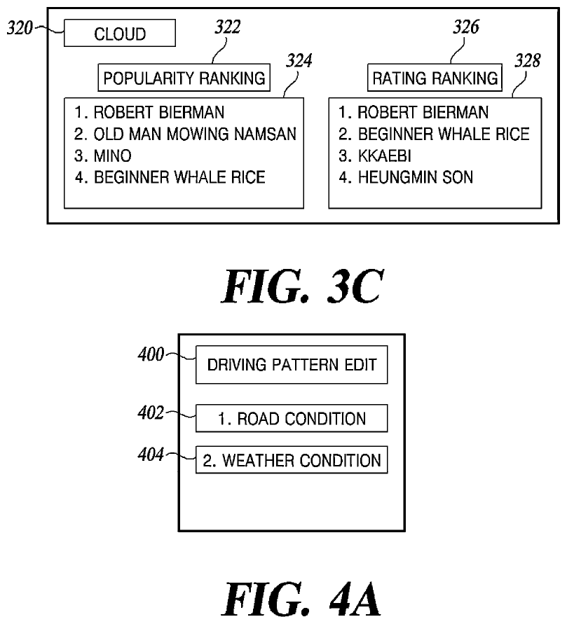

FIGS. 3A-3C are diagrams of a screen displayed on the input-output unit 100 of the customized autonomous driving apparatus according to one embodiment of the present disclosure.

Referring to FIG. 3A, a driving pattern selection 300, a wife mode 302, a husband mode 304, a Robert Bierman mode 306, and a cloud access window (e.g., cloud connection window) 308 are displayed using the input-output unit 100. Here, the husband mode, the wife mode, and the Robert Bierman mode are the names of each driving pattern and are driving patterns in which different users or different driving methods of the same user are stored. The user can input by touching the icon of the driving environment he/she wants to use. Each of the driving pattern modes 302, 304, and 306 may be displayed to include one or more of a picture, a name of the driving pattern, a storage date, and particulars. For example, as particulars of the Robert Bierman mode 306, it may be indicated that this driving pattern mode is the third most downloaded driving pattern in the cloud device.

When the input is made by touching the cloud access window 308, it is connected to the cloud device 320 online. The cloud device 320 is a kind of device that builds a database about the driving patterns. The cloud device 320 may receive and store the driving patterns stored in all customized autonomous driving apparatuses and may transmit the stored driving patterns to all customized autonomous driving apparatuses.

Referring to FIG. 3B, when the user touches and inputs the wife mode 302 illustrated in FIG. 3A, the wife mode title 310 and the wife mode content 312 are displayed on the input-output unit 100.

Referring to FIG. 3C, when the user touches and inputs the cloud access window 308 illustrated in FIG. 3A, it is possible to connect to the cloud device 320 online. When accessing the cloud device 320, there are driving patterns and driving histories that the cloud device 320 receives from the plurality of customized autonomous driving apparatuses and builds a database. The plurality of customized autonomous driving apparatuses may receive and store the driving patterns and driving history data in this database.

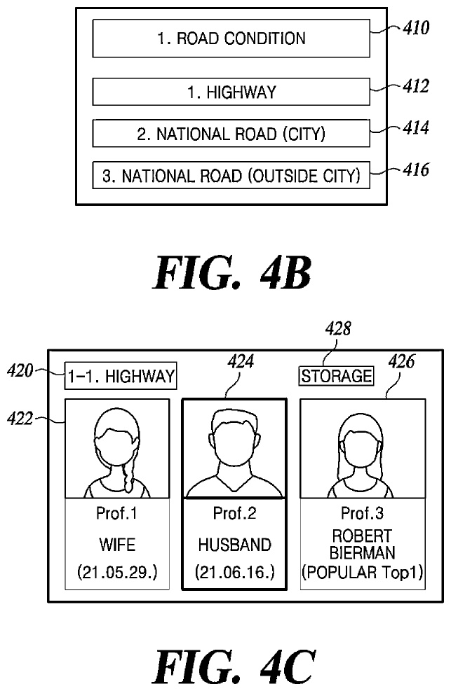

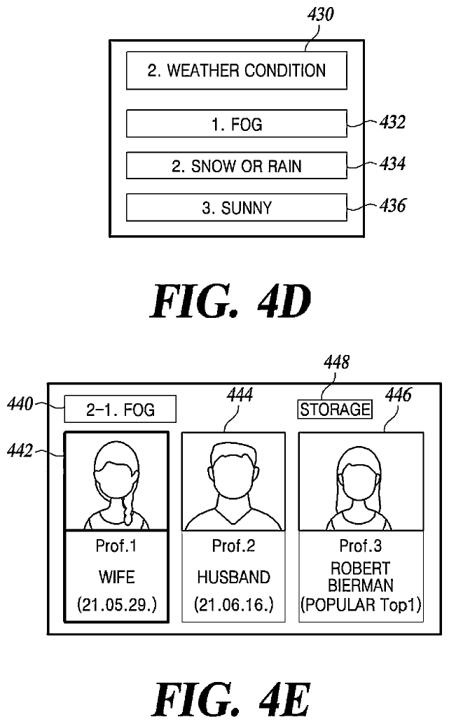

FIGS. 4A-4E are diagrams of a screen for the customized autonomous driving apparatus to edit a new driving pattern by combining the plurality of driving patterns according to one embodiment of the present disclosure.

Referring to FIG. 4A, when a user inputs a driving pattern edit 400, a road condition 402, and a weather condition 404, the inputs are displayed on the input-output unit 100. However, conditions 402 and 404 displayed on the screen are only an example and may further include conditions such as a traffic volume (not illustrated), an expected arrival time (not illustrated), and a driving time (not illustrated) desired by the user.

Referring to FIG. 4B, when the user touches and inputs the road condition 402 illustrated in FIG. 4A, a highway 412, a city national road 414, and an intercity national road 416 are displayed on the input-output unit 100. However, each road condition displayed on the input-output unit 100 is only an example and may further include conditions such as a child protection area (not illustrated), a multi-seater lane (not illustrated), and an unpaved road (not illustrated).

Referring to FIG. 4C, when the highway 412 illustrated in FIG. 4B is touched and input, the wife mode 422, the husband mode 424, and the Robert Bierman mode 426 are displayed on the input-output unit 100. The user may input one driving pattern mode among the driving pattern modes in a situation in which the user is driving on a highway. In the case of FIG. 4C, since the user inputs the husband mode 424 in the highway condition 420, the autonomous driving unit 140 performs the autonomous driving based on the husband mode 424 in a situation where the vehicle is driving on the highway.

In other words, FIG. 4C is a driving pattern editing process in which driving patterns suitable for each road condition are combined and input so that the customized autonomous driving apparatus automatically changes the autonomous driving pattern in response to a change in road conditions.

Referring to FIG. 4D, when the user touches and inputs the weather condition 404 illustrated in FIG. 4A, a fog condition 432, a snow or rain condition 434, and a sunny condition 436 is displayed on the input-output unit 100. However, the conditions for fog condition 432, snow or rain condition 434, and sunny condition 436, displayed on the screen, are merely an example and may further include conditions such as humidity (not illustrated), temperature (not illustrated), illuminance (not illustrated), or the like.

Referring to FIG. 4E, when the fog condition 432 that is illustrated in FIG. 4D is touched and input, the wife mode 442, the husband mode 444, and the Robert Bierman mode 446 are displayed on the input-output unit 100. For example, when there is foggy weather, the user may input one driving pattern mode among the driving pattern modes wife 442, husband 444, and Robert Bierman 446. In the case of FIG. 4E, since the user inputs the wife mode 442 in the foggy condition 440, the autonomous driving unit 140 performs the autonomous driving based on the wife mode 442 in a foggy situation.

In other words, FIG. 4E is a driving pattern editing process in which the driving patterns suitable for weather are combined and input so that the customized autonomous driving apparatus automatically changes the autonomous driving pattern in response to a change in weather.

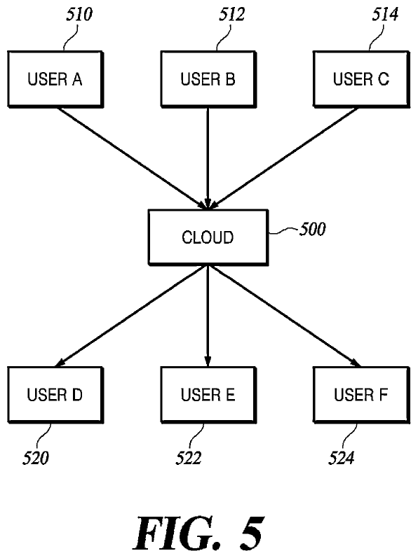

FIG. 5 is a diagram of a method of exchanging data between a plurality of customized autonomous driving apparatuses and one cloud device according to one embodiment of the present disclosure.

Referring to FIG. 5, the cloud device 500 receives and stores the driving patterns stored in the customized autonomous driving apparatuses 510, 512, and 514 of user A, user B, and user C. The cloud device 500 may build a database based on the driving patterns received from the plurality of customized autonomous driving apparatuses 510, 512, and 514. Based on the built database, the cloud device 500 may transmit the stored data to the customized autonomous driving apparatuses 520, 522, and 524 of other users.

Although it is described that each process is sequentially executed in the flowchart of the present disclosure, this is merely illustrative of the technical idea of some embodiments of the present disclosure. In other words, those having ordinary skill in the art to which some embodiments of the present disclosure pertain may change and implement the processes described in the flowchart of the present disclosure. Further, various modifications and variations may be applied by executing one or more processes in parallel among processes without departing from the essential characteristics of some embodiments of the present disclosure. Thus, the flowchart of the present disclosure is not limited to a time-series order.

Various implementations of the apparatus and methods described herein may be implemented by a programmable computer. The computer includes a programmable processor, a data storage system (including volatile memory, non-volatile memory, or other types of storage systems or combinations thereof), and at least one communication interface. For example, a programmable computer may be one of a server, a network appliance, a set-top box, an embedded device, a computer expansion module, a personal computer, a laptop, a Personal Data Assistant (PDA), a cloud computing system, and a mobile device.

According to one embodiment, the customized autonomous driving apparatus can receive and store driving patterns of other users from the cloud device. Thus, it is possible to perform the autonomous driving based on various driving patterns.

According to one embodiment, when using the customized autonomous driving apparatus, even when driving other vehicles other than an own vehicle, the user can perform autonomous driving by applying the customized autonomous driving apparatus to other vehicles based on the driving pattern used in the own vehicle.

According to one embodiment, the cloud device can receive driving patterns from the plurality of customized autonomous driving apparatuses and build a database. The cloud device can also provide users with the number of downloads of driving patterns and in the order of their satisfaction. Therefore, a good driving pattern can be provided to the users.

Although embodiments of the present disclosure have been described for illustrative purposes, those having ordinary skill in the art should appreciate that various modifications, additions, and substitutions are possible, without departing from the idea and scope of the claimed inventive concept. Therefore, embodiments of the present disclosure have been described for the sake of brevity and clarity. The scope of the technical idea of the embodiments of the present disclosure is not limited by the illustrations. Accordingly, one of ordinary skill in the art would understand the scope of the claimed disclosure is not to be limited by the above explicitly described embodiments but by the claims and equivalents thereof.

### REFERENCE NUMERALS

100: input-output unit
110: driving pattern learning unit
120: driving pattern storage unit
130: driving pattern editing unit
140: autonomous driving unit
150: driving history storage unit
160: driving route provision unit
170: communication unit
180: cloud device

What is claimed is:

1. A customized autonomous driving apparatus comprising:
an input-output unit configured to receive data input using one or more of a touch screen, a graphic user interface (GUI), and speech recognition, and configured to visually and audibly output data received from another unit;
a driving pattern learning unit configured to learn a driving pattern of a user with respect to one or more of information on acceleration, braking, steering, inter-vehicle distance, lane change, overtaking, and a response to road facilities, based on a process the user performs when driving;
a driving pattern storage unit configured to store the driving pattern learned by the driving pattern learning unit; and
an autonomous driving unit configured to perform autonomous driving based on one driving pattern input by the input-output unit.

2. The customized autonomous driving apparatus of claim 1, further comprising a driving pattern editing unit configured to edit a combination into a new driving pattern by combining a plurality of previously stored driving patterns with respect to one or more criteria of a road type, a weather condition, and a traffic volume,
wherein the driving pattern storage unit stores the edited driving pattern as a new driving pattern.

3. The customized autonomous driving apparatus of claim 1, further comprising a communication unit configured to transmit the driving pattern stored by the driving pattern storage unit to a cloud device and receive the driving pattern stored by the cloud device,
wherein the driving pattern storage unit stores the driving pattern received by the communication unit.

4. The customized autonomous driving apparatus of claim 1, further comprising a driving route provision unit configured to receive a destination using the input-output unit, generate a driving route from a current position of the user to the input destination, and provide the driving route to the user using the input-output unit.

5. The customized autonomous driving apparatus of claim 4, further comprising a driving history storage unit configured to store a driving history including one or more of a driving route through which a vehicle travels from a departure point of the vehicle toward the destination, a gradient of the driving route, a distance, a time, an average speed, a traffic volume, and whether an accident occurred, when the vehicle arrives at the destination,
wherein the driving route provision unit further generates a driving route based on the stored driving history.

6. A customized autonomous driving method comprising:
an input/output process of receiving data input using an input-output device including one or more of a touch screen, a graphic user interface (GUI), and speech recognition, and of visually and audibly outputting data received from another unit using the input-output device;
a driving pattern learning process of learning a driving pattern of a user with respect to one or more of information on acceleration, braking, steering, inter-vehicle distance, lane change, overtaking, and a response to road facilities, based on a process the user performs when driving;
a driving pattern storing process of storing the driving pattern learned in the driving pattern learning process; and
a process of performing autonomous driving based on one driving pattern input by the input-output unit.

7. The customized autonomous driving method of claim 6, further comprising a driving pattern editing process of editing a combination into a new driving pattern by combining a plurality of previously stored driving patterns with respect to one or more criteria of a road type, a weather condition, and a traffic volume,
wherein in the driving pattern storing process, the edited driving pattern is stored as a new driving pattern.

8. The customized autonomous driving method of claim 6, further comprising a communication process of transmitting the previously stored driving pattern to a cloud device and receiving the driving pattern stored by the cloud device,
wherein in the driving pattern storing process, the driving pattern received in the communication process is stored.

9. The customized autonomous driving method of claim 6, further comprising a driving route provision process of receiving a destination using the input-output device, generating a driving route from a current position of the user to the input destination, and providing the driving route to the user using the input-output unit.

10. The customized autonomous driving method of claim 9, further comprising a driving history storing process of storing a driving history including one or more of a driving route through which a vehicle travels from a departure point of the vehicle toward the destination, a gradient of the driving route, a distance, a time, an average speed, a traffic volume, and whether an accident occurred, when the vehicle arrives at the destination,
wherein, in the driving route provision process, a driving route is further generated based on the stored driving history.

11. A cloud device configured to receive a driving pattern stored by a plurality of customized autonomous driving apparatuses, build a database based on the received driving pattern, and transmit the built data to the plurality of customized autonomous driving apparatuses to a plurality of different customized autonomous driving apparatuses.
